(19) United States
(12) Patent Application Publication
(10) Pub. No.: US 2015/0079230 A1
(43) Pub. Date: Mar. 19, 2015

(54) METHOD FOR INCREASING YIELD IN THE MALTING PROCESS

(71) Applicant: Cargill, Incorporated, Wayzata, MN (US)

(72) Inventor: Katrina Christiansen, Jameston, ND (US)

(73) Assignee: Cargill, Incorporated, Wayzata, MN (US)

(21) Appl. No.: 14/395,515

(22) PCT Filed: Apr. 19, 2013
(86) PCT No.: PCT/US2013/037443

§ 371 Date: Oct. 20, 2014

Related U.S. Application Data
(60) Provisional application No. 61/637,580, filed on Apr. 24, 2012.

(51) Int. Cl. A23L 1/186

(52) U.S. Cl. CPC A23L 1/186; A23V 2002/00
USPC 426/28

(57) ABSTRACT

Processes for increasing yield in the malting process are described. Utilization of an extract in the germination stage of the malting process can result in an increased malt yield without substantially affecting the quality of the resulting malt.

### FIELD OF THE INVENTION

The present invention relates generally to increasing yield in the malting process utilizing a cereal grain extract, preferably a barley extract.

### BACKGROUND OF THE INVENTION

Malted grains are used to make many foods and beverages for humans and animals. Most importantly, malted barley is used in the brewing industry to make beer. Millions of tons of barley and other cereal grains are malted every year for use in beer, foods, and beverages.

### SUMMARY OF THE INVENTION

The present invention features a process for increasing yield in the malting process. The process includes applying an extract to germinating cereal grain in the germination stage of the malting process.

Applicants have surprisingly discovered that the application of this extract in the germination stage of the malting process results in an increased malt yield without substantially affecting the quality of the resulting malt.

In some embodiments, the extract is a barley extract. In other embodiments, the cereal grain is barley. In yet other embodiments, the extract is sprayed onto the cereal grain in the germination stage of the malting process.

In some embodiments, the barley extract that is applied to the barley in the germination stage of the malting process is obtained from steepwater in the steeping stage of the same malting process.

In some embodiments, the barely extract is produced by submerging barley in water for at least 6 hours. In other embodiments, the barley extract is produced by submerging barley in water for at least 15 hours.

In some embodiments, the ratio of water to barley used to produce the barley extract is less than 10:1. In other embodiments, the ratio of water to barley used to produce the barley extract is less than 3:1.

In some embodiments, the barley extract is applied to the cereal grain within 48 hours from the start of germination. In other embodiments, the barley extract is applied to the cereal grain within 24 hours from the start of germination. In yet other embodiments, the barley extract is applied to the cereal grain between 4 hours and 30 hours from the start of germination.

### DETAILED DESCRIPTION OF THE INVENTION

### Definitions

The term “extract”, as used herein, means compositions obtained from cereal grains or parts thereof, for example barley, wheat, buckwheat, rye, maize, rice, and oats, by isolation methods described herein. Preferably the extract utilized in the present invention is a barley extract.

The extract can be produced by submerging or contacting the cereal grain with water for a particular period of time, for example for 1, 2, 5, 10, 24, or 48 hours. While the cereal grain is submerged in the water, the cereal grain typically absorbs some of the water. At the same time, some portion of the cereal grains is extracted into the water. After submersion for a sufficient period of time, the cereal grain is separated from the water, resulting in an extract.

In some embodiments, the extract is steepwater obtained from the steeping stage in a malting process. In some embodiments, the steepwater used as an extract is the same steepwater as that used to malt a particular batch of barley. In other embodiments, the steepwater used as an extract can be steepwater obtained from the steeping of a different batch of barley (or other cereal grains).

The steepwater can be either from the first steeping of the cereal grain in a malting process. Alternately it can be from the second, third or later steeping.

In other embodiments, extract is produced by purposefully contacting cereal grains with water for a particular period of time, particular manner, and at particular cereal grain to water ratios to extract components of the cereal grain into the water. The cereal grains can be submerged in water or brought in contact with water in any other manner known in the art. Ambient temperatures may be used in the extraction, as well as elevated or reduced temperatures. Pressure may be modified to produce the extract as well.

The ratio of cereal grain to water used to produce an extract can be varied. In some embodiments, the ratio of water to cereal grain is less than 100:1 by weight. In other embodiments, the ratio of water to cereal grain is less than 50:1 by weight. In yet other embodiments, the ratio of water to cereal grain is less than 25:1 by weight.

In some particularly preferred embodiments, the ratio of water to cereal grain is less than or equal to about 10:1 by weight. In other preferred embodiments, the ratio of water to cereal grain is less than or equal to about 5:1 by weight. In yet other preferred embodiments, the ratio of water to cereal grain is less than or equal to about 3:1 by weight. In yet other preferred embodiments, the ratio of water to cereal grain is less than or equal to about 2:1 by weight. In yet other preferred embodiments, the ratio of water to cereal grain is less than 1.5:1 by weight. In yet other preferred embodiments, the ratio of water to cereal grain is less than or equal to about 1:1 by weight.

The amount of time that the barley can be submerged in water to produce the extract can be varied. In some embodiments, the barley can be submerged in water for more than 1 hour. In other embodiments, the barley can be submerged in water for more than 4 hours. In some particularly preferred embodiments, the barley can be submerged in water for more than 6 hours. In other particularly preferred embodiments, the barley can be submerged in water for more than 10 hours. In yet other particularly preferred embodiments, the barley can be submerged in water for more than 15 hours. In yet other particularly preferred embodiments, the barley can be submerged in water for more than 18 hours.

The extract, once produced, can be manipulated in a number of ways prior to being utilized in the present invention. In some embodiments, the extract can be heated. The heating can be used to kill bacteria in the extract. Heating can also be used to concentrate the extract. For example, by evaporating off half of the water in the extract, the extract can be said to be concentrated to two times strength. The extract can be concentrated by other methods known in the art.

Thus, there are three main methods of increasing the components extracted from cereal grains into an extract. The first is to increase the ratio of cereal grain to water when producing an extract. By using greater amounts of cereal grain with an amount of water, a larger amount of materials will be extracted from the cereal grains into the extract. Second, the cereal grains can be submerged in water for longer periods of time. Finally, the extract can be heated to evaporate a portion of the water off of the extract.

Due to the variation in barley varieties and differences in germination equipment, slightly different parameters can be used to produce the ideal extract which can provide the greatest benefit to the commercial maltster.

In some embodiments, the extract can be diluted prior to use in the present invention. Water can be added to the extract to dilute the concentration of components in the extract.

In some embodiments, the extract can be additionally processed prior to utilization in the germination stage of the malting process. This further processing can include, for example flash pasteurization of the extract in order to kill bacteria in the extract. In other embodiments, the extract can be filtered or defoamed. Filtering can be conducted using ultrafiltration, nanofiltration, or other filtration technologies known in the art.

### General Malting Process

The malting process is well known in the art. Many cereal grains can be malted including, but not limited to, barley, wheat, buckwheat, rye, maize, rice, and oats. Cereal grains can be malted to modify their kernel structure, composition and enzyme content. The resulting malts have many important uses in food for animals and humans. The most important malted material is malted barley, which is used in the brewing and distilling industries. The malting process and the present invention will be described below for barley, but it is understood that the present invention can be utilized in the malting of other types of cereal grains, and that the extract could be a cereal grain extract other than barley extract.

The process of malting barley consists primarily of three stages: steeping, germination, and kilning. The three main stages of malting will be described in greater detail in individual sections below. Prior to steeping, barley kernels can go through some processing to select and prepare them for the malting process. Specifically, barley kernels can be cleaned and stored for a period of time prior to steeping. Additionally, because different size barley kernels absorb moisture at different rates, it can be desirable to process uniform kernel sizes to improve product uniformity and quality.

Factors such as the protein content of the barley, water quality, and configuration of infrastructure can also contribute to variability of moisture uptake. In addition, it is understood that a large number of factors ranging from agronomy to barley variety to process infrastructure can contribute to variability in rate of moisture uptake of barley kernels, and are considered during grain selection and sorting. Once the appropriate kernels are selected and prepared, these kernels are then steeped.

Steeping refers to the immersion of barley kernels in water to increase the moisture content of the kernels. The water used in the steeping stage of a conventional malting process is typically discarded. After steeping, the barley kernels are typically transferred to germination compartments to undergo the germination process. Germination refers to a period of controlled growth and modification of the kernels. Modification of barley kernels is well known in the art to encompass cell wall degradation in the starchy endosperm, creation of soluble proteins and free amino nitrogen, and synthesis of desirable enzymes. After the barley kernels have been modified to the desired degree, the grains are subjected to the kilning stage. Kilning refers to the controlled drying of the germinated barley.

After kilning is complete, the kernels are screened during which time the bulk of rootlets and in some cases acrospires are separated from the kernels. The separated rootlets, acrospires, as well as grain respiration which occurs during malting, represent a loss in the malting process, the so called “malting loss”. The amount of malted barley remaining after completion of the malting process and removal of rootlets, acrospires, and other undesirable materials is referred to as the malt yield. The present invention provides a simple to use process improvement which, when incorporated into a conventional malting process, provides a yield improvement over such a conventional malting process. In addition, the process improvement does not introduce materials that other than barley components and water to the malting process in order to increase yield. The present invention can also be easily incorporated into conventional malting processes without significant need for new equipment or complex process steps. The conventional malting process is well known in the art and, for example, is described in D. E. Briggs, Malts and Malting, Springer (1998); D. E. Briggs, J. S. Hough, R. Stevens, and T. W. Young, Malting and Brewing Science, Volume 1, Malt and Sweet Wort, Springer Verlag (1981); A. W. MacGregor and R. S. Bhatty, eds., Barley: Chemistry and Technology, American Association of Cereal Chemists (1996).

### Steeping

The first main stage of the malting process is the steeping of the barley kernels. The barley kernels are immersed in water which may or may not be aerated. Typically, steeping can include a series of water immersions. These water immersions can be separated by periods of air rest under ventilation.

During steeping, respiration of the barley begins and heat and gases are given off although no significant growth takes place. The goal of steeping is to increase the moisture level of the barley kernels from approximately 10% as harvested to 40-45% moisture. Properly hydrating the barley to target moisture levels can be accomplished by manipulation of immersion times, air rest time, and immersion water temperature among other infrastructure and process recipe means. When steeping is completed, the embryo is swollen with moisture and is generally visible. Tips of the barley rootlets are generally just appearing. This visible swelling of the embryo and emergence of the rootlets is referred to as “chitting”.

The conventional steeping of barley is well known in the art. Aspects of steeping are described, for example, in D. E. Briggs, Malts and Malting, Springer (1998); D. E. Briggs, J. S. Hough, R. Stevens, and T. W. Young, Malting and Brewing Science, Volume 1, Malt and Sweet Wort, Springer Verlag (1981); A. W. MacGregor and R. S. Bhatty, eds., Barley: Chemistry and Technology, American Association of Cereal Chemists (1996).

### Germination

The second main stage of the malting process is germination. Germination broadly involves subjecting the steeped barley kernels to appropriate conditions of temperature, moisture, and airflow for a time sufficient for the starchy interior portion of the barley kernel (the endosperm mass) to be made more friable and modified by cell wall degradation, and growth of the embryo facilitated. Growth typically begins slowly on the first day of germination, and accelerates during the second day. Most germinations are 4 day processes, though 3 day processes are also known as well as germination processes which can last 5 or more days.

During germination, the barley kernel completes chitting and rootlets grow outwardly from the embryo of the kernel. The acrospire (also known as “first leaf”) also starts to grow from the embryo at the base of the kernel and grows under the hull toward the top end of the kernel. Growth of the acrospire in germination is a key parameter monitored by the commercial maltster. Typically, it is desired for well-modified malt to have the acrospire reaching ¾ to 100% of the kernel length by the end of germination. Malt products desiring a lower degree of modification may be ½ to ¾ or less than 100% the length of the kernel. Malt products requiring an extremely high degree of modification may be well in excess of 100% of the kernel, and may even have acrospires past the end of the kernel by 100% or more the length of the kernel.

Germination compartments generally use a slotted screen false floor allowing the compartment to receive a continuous humidified and temperature controlled airflow and allowing excess moisture to drain through the bed. Germination compartments are equipped with turning machines, or some means for turning the germinating barley kernels, approximately every 8 hours to minimize temperature differences between the top and bottom of the germination bed and to prevent rootlets from growing together and matting. Large air handling fans are used to transfer fresh air, recirculation air, and/or any blend of fresh and recirculation air through water spray humidification and temperature controlled chambers, and force the air through the germinating grain. The barley kernels, during growth, give off considerable heat and carbon dioxide. It is important to near continuously pass temperature controlled humidified air through the germination compartment to remove the carbon dioxide and heat produced by grain respiration, as well as to slow the rate of moisture loss, provide a means of controlling the germination compartment temperature, and control overall rate of barley growth.

Turning machines, used to turn germinating barley kernels and prevent rootlets from growing together, are typically equipped with a spray bar capable of delivering water to the growing barley. Other means of applying water to the barley are also possible. Generally, the germinating barley loses approximately 1% moisture per day during germination. The spray bars can be used to add back this lost moisture, and increase moisture level if desired, to the germinating barley through a metered watering.

Generally, sufficient water is applied to the germination compartment to wet the germinating barley, while allowing a minimal amount to leak out the bottom of the germination compartment. The germinating barley is ready to water when it is dry of surface moisture from steeping or a previous watering. Typically, after 24 hours from the start of the germination stage, the germinating barley is ready for its first watering. Depending on the initial moisture level of the barley kernels out of the steeping stage, the process goals for degree of modification, or customer specification, watering may occur every 8-12 hours after the initial watering. A second, third, fourth, or more waterings may be used. During germination, the moisture level of the barley increases from approximately 40%-45% at the beginning of germination to approximately 45%-50%. It is understood that different conditions and parameters can be used in the germination stage of the malting process depending on the barley conditions, the variety of barley starting material, the desired attributes of the malt output, and the size, type, or other physical attributes and limitations of the particular germination compartment used.

Barley respiration, rootlet growth, and acrospires are considered typical examples of malting loss. In the case of respiration loss, the barley releases carbon dioxide as a byproduct of metabolic activity which consumes grain mass. In the case of rootlet growth, rootlets are formed consuming grain mass and subsequently cleaned off following kilning. Acrospires in excess of the kernel length or that grow outside of the husks are also cleaned off following kilning, resulting in a loss of saleable malt mass. Though acrospires in excess of kernel length and rootlets retain minimal value in residual feed streams, they are a significant loss to the malting process.

The germination stage of the malting process is well known in the art. Certain aspects of germination are described, for example, in D. E. Briggs, Malts and Malting, Springer (1998); D. E. Briggs, J. S. Hough, R. Stevens, and T. W. Young, Malting and Brewing Science, Volume 1, Malt and Sweet Wort, Springer Verlag (1981); A. W. MacGregor and R. S. Bhatty, eds., Barley: Chemistry and Technology, American Association of Cereal Chemists (1996).

The present invention features a process for improving malt yield. This process includes applying an extract to germinating cereal grains, preferably barley, in the germination stage of the malting process. The extract is preferably a barley extract. The optimal level of concentration of the extract and particular time of application of the extract during the germination stage of the malting process may vary based on certain factors such as the variety of barley being malted, the size, type, or other physical attributes and limitations of the particular germination compartment used, ambient environmental conditions, seasonal weather variations, and the key malting attributes desired for commercial consideration such as degree of modification, degree of enzyme development, among other attributes. In addition, the particular barley variety used to produce the extract can vary depending on the characteristics of the extract desired.

Two principal types of cultivated barley are used in the malting process, 2-row and 6-row. Cultivated barley can further be broken into fall planted winter barley, and spring planted spring barley. Each of these types of barley has several varieties which are used in the malting industry. A malt barley variety refers to a variety of barley typically cultivated and developed from a barley breeding program. Barley variety development will typically utilize germ plasm collections to develop varietal traits most beneficial to desired malt quality, and desired agronomical characteristics. Malting quality barley varieties are in development in the private sector, through governments, universities, and amongst national and international organizations.

Different barley varieties have different characteristics. Moreover, these varieties are constantly being modified, in some cases due to nature, but primarily due to the desire to produce new varieties of barley having particularly desired characteristics such as better agronomic capability, better germination capability, and low protein content, among others.

Since the characteristics in each variety can vary, the malting parameters may also need to be varied depending on the properties of the resulting malt desired. Similarly, certain parameters of the present invention (particularly the characteristics of the extract used, and time of addition of the extract) may also vary to obtain optimal increase in malt yield based on the variety used and the desired properties of the resulting malt.

Examples of barley varieties include Sebastian, Moravian, Copeland, Tipple, Metcalfe, Tradition, Scarlett, Barke and Stellar. This list is not exclusive as there are hundreds of barley varieties and more are constantly being created.

Different types of germination compartments can be used in the germination stage of the malting process. These compartments can vary in size, depth, method of water application, method of humidification, and temperature control among other differences. These differing physical characteristics may affect the extract and particular time of application of the extract in the germination stage of the malting process.

The extract can be applied to the germinating grains in any manner known in the art. In some embodiments, the extract can be sprayed onto the germinating grains. In these embodiments, a spray bar connected to a turning device may be used to spray the germinating grains with the extract.

The extract can be applied to the germinating grains at any time during the germination stage of the malting process useful for improving malt yield. Certain embodiments may call for an earlier application of extract to the germinating grains while other embodiments may call for a later application. These differences may be due to physical characteristics of the germination compartment used as well as the variety of barley being malted.

In some embodiments, the extract can be applied within 72 hours from the start of germination. In other embodiments, the extract can be applied within 48 hours from the start of germination In yet other embodiments, the extract can be applied within 40 hours from the start of germination. In yet other embodiments, the extract can be applied within 32 hours from the start of germination. In yet other embodiments, the extract can be applied within 28 hours from the start of germination.

In some particularly preferred embodiments, the extract can be applied within 24 hours from the start of germination. In other preferred embodiments, the extract can be applied within 20 hours from the start of germination. In yet other preferred embodiments, the extract can be applied between 4 hours and 30 hours from the start of germination. In yet other preferred embodiments, the extract can be applied between 4 hours and 24 hours from the start of germination. In yet other preferred embodiments, the extract can be applied between 8 hours and 20 hours from the start of germination.

In other embodiments, the extract can be applied to the germinating grains at the time that the first, second, and/or third watering would normally occur. That is, rather than apply water onto the germinating grain, the extract can be applied onto the germinating grain.

In some preferable embodiments, the extract can be applied at least at the time the first watering would occur. The first watering typically occurs 24 hours from the start of the germination stage, however, the precise time of the first watering can vary depending on a number of factors such as barley variety and vigor of germination. In other embodiments, the extract can be applied to the germinating grains each time a watering is called for.

Another aspect of the present invention features the use of an extract in the germination stage of the malting process. The extracts are those described above.

### Kilning

The third main stage of the malting process is kilning. In the kilning process the germinated barley (green malt) is heated in a kiln to reduce its moisture content and stop further growth. Kilning is typically comprised of 3 phases: wither, pre-cure/post wither, and cure. Green malt is typically transferred to a kiln immediately following germination. Most commercial kilns are slotted floor false bottom allowing air to pass through the green malt. Kilns usually have a means to minimally level the green malt bed for efficient drying, and may utilize turning machines as in germination to mix, turn, or level the green malt bed. Kilning is essentially a process of performing a regulated removal of water from the green malt.

The first main phase of kilning is the wither phase. In this phase the green malt at approximately 45% moisture at the end of germination is subjected to moderate temperature and high volume airflow. Generally, the temperature applied to the bed in the wither phase is maintained at approximately 60° C. and the moisture content of the grain is reduced from initial kiln loading levels to approximately 20%-25%. During the wither phase, germination continues during the initial period when the grain still contains high levels of moisture, but growth and modification slows and stops once the rootlets are “withered”, with removal of all surface moisture as well as the more easily removed moisture in the embryo area of the grain.

In the second phase of kilning, the pre-cure/post wither phase, moisture level in the grain is reduced from approximately 20%-25% to approximately 12%-15%, and the grain appears dry to the touch. Applied temperature is increased and airflow is typically decreased in this phase.

In the third phase of kilning, the cure phase, the temperature is increased to the maximum set point for the process, kiln, or the desired malt outcome. The cure phase typically defines the product color and flavor development of the malt, as well as driving off undesirable volatiles, and reducing final product moisture content to a microbiologically, food safe level of approximately 4%. Curing generally involves heating the malt to approximately 85° C. for a period of 2 to 4 hours. Temperatures used and time applied, however, vary widely among commercial maltsters, and among product lines being produced. The kilning stage is well known in the art. Certain aspects of kilning are described, for example, in D. E. Briggs, Malts and Malting, Springer (1998); D. E. Briggs, J. S. Hough, R. Stevens, and T. W. Young, Malting and Brewing Science, Volume 1, Malt and Sweet Wort, Springer Verlag (1981); A. W. MacGregor and R. S. Bhatty, eds., Barley: Chemistry and Technology, American Association of Cereal Chemists (1996).

The present invention provides a process for increasing malt yield while providing malted barley useful for brewing. Utilizing an extract, preferably a barley extract in the germination stage of the malting process can provide an increased malt yield compared to a comparable conventional malting process which does not incorporate the present invention.

The benefits provided by the present invention are exemplified in the examples below. These examples show that utilization of the present invention can result in an increase in malt yield of up to 1% or even higher while providing malted barley useful for brewing, distilling, or other food and beverage applications. Such an improved malt yield can bring about considerable financial benefits to a commercial maltster. In addition, incorporation of the present invention to a conventional malting process does not require significant capital expenditure. The present invention provides a cost effective and easy to use malting process improvement which surprisingly improves malt yield while maintaining desired malt quality attributes.

### EXAMPLES

The present invention is further illustrated by the examples provided below. It is understood that these examples are not intended to limit the scope of the present invention in any way.

### Example 1

A Joe White micro-malting system was used test 16 samples of barley from 4 different varieties (Sebastian, Tipple, Prestige, and Bellini) and using different extracts. This micro-malting system allows for steeping, germination, and kilning of samples in one unit while providing uniformity of malting conditions for each batch. Each sample was placed in one compartment of the micro-malting system. A sample of 0.5 kilogram of barley was added to each of the compartments in the micro-malting unit for malting. Table 1 describes experimental conditions utilized in this example.

TABLE 1

| Compartment/ | Barley | Spray Used in |
|---|---|---|
| Sample | Variety | Germination Stage |
| 1 | Sebastian | Reference (Water) |
| 2 | Sebastian | Sebastian 100% Spray |
| 3 | Sebastian | Reference (Water) |
| 4 | Sebastian | Sebastian 50% Spray |
| 5 | Tipple | Reference (Water) |
| 6 | Tipple | Tipple 100% Spray |
| 7 | Tipple | Reference (Water) |
| 8 | Tipple | Tipple 50% Spray |
| 9 | Prestige | Reference (Water) |
| 10 | Prestige | Prestige 100% Spray |
| 11 | Prestige | Reference (Water) |
| 12 | Prestige | Prestige 50% Spray |
| 13 | Bellini | Reference (Water) |
| 14 | Bellini | Bellini 100% Spray |
| 15 | Bellini | Reference (Water) |
| 16 | Bellini | Bellini 50% Spray |

Three immersions steeping cycle was used for all barley samples. The barley was steeped with the first water immersion for 6 hours at a temperature of 15° C. Following the water immersion, the barley was subjected to air ventilation for 12 hours at a temperature of 15° C. The second immersion was for 5 hours followed by air ventilation for 10 hours at 15° C. The third immersion was for 2 hours at 15° C. After steeping was completed, germination began and progressed for 5 days. The germinating barley was subjected to humidified air at a temperature of 15° C. The barley in each compartment was sprayed with water or a barely extract at 15 hours on day 1. Since the targeted moisture level of the barley at the end of germination was 43-44%, the barley in each compartment was not sprayed on days 2 though 5. Table 2 below describes moisture content of the barley in each compartment at the end of days 1 through 5, as well as the amount of water or extract sprayed onto the barley at 15 hours on day 1.

TABLE 2

| | Day 1 | | Day 2 | | Day 3 | | Day 4 | | Day 5 | |
|---|---|---|---|---|---|---|---|---|---|---|
| Compartment | Moist | Spray | Moist | Spray | Moist | Spray | Moist | Spray | Moist | Spray |
| 1 | 43.5% | 30 mL | 46.4% | — | 46.5% | — | 45.9% | — | 45.7% | — |
| 2 | 43.5% | 30 mL | 46.0% | — | 46.0% | — | 45.2% | — | 44.9% | — |
| 3 | 43.7% | 30 mL | 46.6% | — | 47.0% | — | 46.9% | — | 45.3% | — |
| 4 | 43.7% | 30 mL | 46.7% | — | 47.6% | — | 46.5% | — | 46.3% | — |
| 5 | 42.0% | 40 mL | 45.0% | — | 44.5% | — | 44.0% | — | 43.3% | — |
| 6 | 42.0% | 40 mL | 45.2% | — | 45.5% | — | 44.6% | — | 44.1% | — |
| 7 | 41.9% | 40 mL | 45.4% | — | 45.4% | — | 44.8% | — | 43.6% | — |
| 8 | 41.9% | 40 mL | 45.6% | — | 45.9% | — | 45.8% | — | 44.4% | — |
| 9 | 43.2% | 30 mL | 45.6% | — | 46.9% | — | 46.9% | — | 45.8% | — |
| 10 | 43.2% | 30 mL | 45.8% | — | 46.7% | — | 45.8% | — | 45.3% | — |
| 11 | 42.9% | 30 mL | 45.7% | — | 46.6% | — | 46.8% | — | 45.5% | — |
| 12 | 42.9% | 30 mL | 45.7% | — | 46.6% | — | 45.6% | — | 44.8% | — |
| 13 | 41.5% | 40 mL | 44.4% | — | 44.8% | — | 43.5% | — | 43.5% | — |
| 14 | 41.5% | 40 mL | 44.0% | — | 44.7% | — | 44.0% | — | 43.3% | — |
| 15 | 42.0% | 40 mL | 44.8% | — | 45.0% | — | 44.6% | — | 43.1% | — |
| 16 | 42.0% | 40 mL | 44.5% | — | 44.6% | — | 43.5% | — | 42.6% | — |

Each of the barley extracts utilized as the sprays (as listed in table 1) were obtained from purposefully producing barley extracts from Sebastian, Tipple, Prestige, and Bellini varieties. Each extract was produced by submerging 1 kg of the particular barley variety in 10 L of water. The mixtures were held for 6 hours. The extracts were either used as is or diluted by 50% with water. For example, for the barley extract made from Sebastian barley, when the barely extract was not diluted prior to its utilization as a spray in the germination stage, this barley extract is referred to as Sebastian 100% Spray. When this barely extract is diluted by 50% with water, it is referred to as Sebastian 50% Spray.

After 5 days of germination, the barley in each compartment was kilned with a standard kilning program.

Malt yield was measured in 1,000 kernel weight for each sample from each of the 16 compartments. Table 3 shows the 1,000 kernel weight for each sample.

TABLE 3

| Compartment/ | Barley | Spray Used in | Malt Yield in 1,000 |
|---|---|---|---|
| Sample | Variety | Germination Stage | Kernel Weight |
| 1 | Sebastian | Reference (Water) | 35.4 |
| 2 | Sebastian | Sebastian 100% Spray | 35.1 |
| 3 | Sebastian | Reference (Water) | 35.1 |
| 4 | Sebastian | Sebastian 50% Spray | 35.9 |
| 5 | Tipple | Reference (Water) | 40.5 |
| 6 | Tipple | Tipple 100% Spray | 41.1 |
| 7 | Tipple | Reference (Water) | 41.4 |
| 8 | Tipple | Tipple 50% Spray | 40.9 |
| 9 | Prestige | Reference (Water) | 39.7 |
| 10 | Prestige | Prestige 100% Spray | 39.4 |
| 11 | Prestige | Reference (Water) | 38.9 |
| 12 | Prestige | Prestige 50% Spray | 40.0 |
| 13 | Bellini | Reference (Water) | 41.1 |
| 14 | Bellini | Bellini 100% Spray | 41.3 |
| 15 | Bellini | Reference (Water) | 41.5 |
| 16 | Bellini | Bellini 50% Spray | 41.5 |

Applicants believe that the extract utilized in this example did not show consistent results due to too high a level of dilution. The high level of dilution could be due to the relatively high ratio of water to barley used to produce the barley extract (10:1 by weight), and/or to the relatively short amount of time that the barley used to produce the extract was submerged in water (6 hours).

### Example 2

As in Example 1, a Joe White micromalting system was used to malt samples of barley. One kilogram of barley was added to each of 8 compartments in the micro-malting unit. Table 4 describes experimental conditions utilized in this example.

TABLE 4

| Compartment/ | Barley | Spray Used in |
|---|---|---|
| Sample | Variety | Germination Stage |
| 1 | Prestige | Reference (Water) |
| 2 | Prestige | Reference (Water) |
| 3 | Prestige | Prestige 100% Spray |
| 4 | Prestige | Sebastian 100% Spray |
| 5 | Sebastian | Reference (Water) |
| 6 | Sebastian | Reference (Water) |
| 7 | Sebastian | Prestige 100% Spray |
| 8 | Sebastian | Sebastian 100% Spray |

A three immersions steep cycle was used. In the first immersion, the barley was immersed in water for 6 hours at 15° C. followed by ventilation for 12 hours at 15° C. In the second immersion, the barley was immersed in water for 5 hours at 15° C. followed by ventilation for 10 hours at 15° C. In the final immersion, the barley was immersed for 2 hours at 15° C. Following steeping, the barley was germinated for 5 days at 15° C. with a target moisture level of 43%-44% at the end of germination. Table 5 below describes moisture content of the barley in each compartment at the end of day 1, 2, 3, 4, and 5, as well as the amount of water or barely extract sprayed onto the barley at 12 hours on day 1.

TABLE 5

| | Day 1 | | Day 2 | | Day 3 | | Day 4 | | Day 5 | |
|---|---|---|---|---|---|---|---|---|---|---|
| Compartment | Moist | Spray | Moist | Spray | Moist | Spray | Moist | Spray | Moist | Spray |
| 1 | 43.9% | 50 mL | 47.3% | — | 48.6% | — | 48.2% | — | 48.5% | — |
| 2 | 43.5% | 50 mL | 45.7% | — | 46.6% | — | 45.7% | — | 46.1% | — |
| 3 | 43.6% | 50 mL | 45.6% | — | 45.7% | — | 45.8% | — | 45.5% | — |
| 4 | 44.6% | 50 mL | 46.1% | — | 46.7% | — | 46.2% | — | 46.7% | — |
| 5 | 44.8% | 50 mL | 45.8% | — | 46.6% | — | 45.8% | — | 45.9% | — |
| 6 | 43.7% | 50 mL | 45.8% | — | 46.3% | — | 45.4% | — | 45.8% | — |
| 7 | 44.3% | 50 mL | 45.5% | — | 46.4% | — | 46.1% | — | 46.3% | — |
| 8 | 44.2% | 50 mL | 46.0% | — | 46.5% | — | 45.5% | — | 45.1% | — |

The barley extracts utilized as the spray (as listed in table 4) were obtained from purposefully producing barley extracts from Prestige and Sebastian varieties. The Prestige barley extract was produced by submerging 500 g of Prestige barley in 1 L of water. The mixture was held for 20 hours with aeration. The temperature of the mixture started at 18° C. at the beginning of the 20 hours and ended at 13.5° C. The Sebastian barley extract was produced in the same manner except that the temperature of that mixture started at 18° C. at the beginning of the 20 hours and ended at 15.9° C. Neither extract was concentrated or diluted, and therefore referred to as 100% spray.

After 5 days of germination, the barley in each compartment was kilned. During the wither phase of kilning, the green malt was heated for 15 hours at 55° C. In the pre-cure/post wither phase, the temperature was gradually increased from 55° C. to 85° C. over 8 hours. During the cure phase, the barley was heated to 85° C. for 3 hours.

Malt yield was measured in 1,000 kernel weight for each of the 8 samples. Table 6 displays this yield data.

TABLE 6

| Compartment/ | Barley | Spray Used in | Malt Yield in 1,000 |
|---|---|---|---|
| Sample | Variety | Germination Stage | Kernel Weight |
| 1 | Prestige | Reference (Water) | 39.4 |
| 2 | Prestige | Reference (Water) | 40.3 |
| 3 | Prestige | Prestige 100% Spray | 40.4 |
| 4 | Prestige | Sebastian 100% Spray | 41.1 |
| 5 | Sebastian | Reference (Water) | 35.7 |
| 6 | Sebastian | Reference (Water) | 35.6 |
| 7 | Sebastian | Prestige 100% Spray | 35.8 |
| 8 | Sebastian | Sebastian 100% Spray | 36.4 |

Table 7 below shows the percentage increase in malt yield for each experimental sample compared to the average malt yield of the two control samples (reference samples) produced from the same barley variety.

TABLE 7

| | Spray Used in | Malt Yield | Percent Yield |
|---|---|---|---|
| Barley | Germination | in 1,000 | Increase compared |
| Variety | Stage | Kernel Weight | to Reference |
| Prestige | Reference (Water) | 39.85 (Avg.) | — |
| Prestige | Prestige 100% | 40.4 | 1.4% |
| | Spray | | |
| Prestige | Sebastian 100% | 41.1 | 3.1% |
| | Spray | | |
| Sebastian | Reference (Water) | 35.65 (Avg.) | — |
| Sebastian | Prestige 100% | 35.8 | 0.4% |
| | Spray | | |
| Sebastian | Sebastian 100% | 36.4 | 2.1% |
| | Spray | | |

As seen in table 7, all of the experimental samples showed an increase in malt yield. In particular, the samples using a Sebastian spray showed a substantial increase in malt yield.

### Example 3

As in Examples 1 and 2, a Joe White micromalting system was again used to malt samples of barley. In this example, however, the steeping stage was conducted in a commercial malting production line, and germination and kilning were conducted in the Joe White micromalting system. Four kg of Sebastian barley and four kg of Azurel barley were obtained from commercial malting production lines.

The four kg Sebastian was separated into one kilogram samples and placed into compartments 1-4. The four kg Azurel was separated into one kilogram samples and placed into compartments 5-8. Table 8 describes experimental conditions utilized in this example.

TABLE 8

| Compartment/ | Barley | Spray Used in |
|---|---|---|
| Sample | Variety | Germination Stage |
| 1 | Sebastian | Reference (Water) |
| 2 | Sebastian | Prestige 100% Spray |
| 3 | Sebastian | Sebastian 100% Spray |
| 4 | Sebastian | Aruzel 100% Spray |
| 5 | Azurel | Reference (Water) |
| 6 | Azurel | Prestige 100% Spray |
| 7 | Azurel | Sebastian 100% Spray |
| 8 | Azurel | Aruzel 100% Spray |

The barley was germinated for 5 days at 15° C. with a target moisture level of 43%-44% at the end of germination. Table 9 below describes moisture content of the barley in each compartment at the end of day 1, 2, 3, 4, and 5, as well as the amount of water or barley extract sprayed onto the barley on each of the days. The barley was sprayed with water or barley extract at 16 hours and again at 35 hours into germination.

TABLE 9

| | Day 1 | | Day 2 | | Day 3 | | Day 4 | | Day 5 | |
|---|---|---|---|---|---|---|---|---|---|---|
| Compartment | Moist | Spray | Moist | Spray | Moist | Spray | Moist | Spray | Moist | Spray |
| 1 | 43.1% | 50 mL | 42.3% | 25 mL | 42.0% | 20 mL | 43.2% | — | 42.5% | — |
| | | water | | water | | water | | | | |
| 2 | 42.0% | 25 mL | 41.3% | 50 mL | 43.1% | — | 42.6% | — | 42.5% | — |
| | | extract | | extract | | | | | | |
| 3 | 41.3% | 35 mL | 41.5% | 50 ml | 43.1% | — | 42.4% | — | 42.2% | — |
| | | extract | | extract | | | | | | |
| 4 | 41.4% | 35 mL | 43.1% | — | 42.2% | 20 mL | 42.0% | — | 42.3% | — |
| | | extract | | | | extract | | | | |
| 5 | 42.2% | 25 mL | 41.7% | 50 mL | 43.0% | — | 42.6% | — | 42.5% | — |
| | | water | | water | | | | | | |
| 6 | 41.1% | 35 mL | 42.0% | 30 mL | 43.3% | — | 43.1% | — | 43.2% | — |
| | | extract | | extract | | | | | | |
| 7 | 41.4% | 35 mL | 41.5% | 50 mL | 43.2% | — | 43.3% | — | 42.9% | — |
| | | extract | | extract | | | | | | |
| 8 | 41.9% | 25 mL | 42.6% | 20 mL | 43.2% | — | 42.6% | — | 42.3% | — |
| | | extract | | extract | | | | | | |

The barley extracts utilized as the spray (as listed in table 8) were obtained from purposefully producing barley extracts from Prestige, Azurel, and Sebastian varieties. The Prestige barley extract was produced by submerging 500 g of Prestige barley in 1 L of water. The mixture was held for 20 hours with aeration. The temperature of the mixture started at 18° C. at the beginning of the 20 hours and ended at 13.5° C. The Sebastian barley extract was produced in the same manner except that the temperature of that mixture started at 18° C. at the beginning of the 20 hours and ended at 15.9° C. The Azurel barley extract was produced in the same manner except that the temperature of that mixture started at 18° C. at the beginning of the 20 hours and ended at 12.9° C. None of the extracts were concentrated or diluted, and are therefore referred to as 100% spray.

After 5 days of germination, the barley in each compartment was kilned. During the wither phase of kilning, the green malt was heated for 15 hours at 55° C. In the pre-cure/post wither phase, the temperature was gradually increased from 55° C. to 85° C. over 8 hours. During the cure phase, the barley was heated to 85° C. for 3 hours.

Malt yield was measured in 1,000 kernel weight for each of the 8 samples. Table 10 displays this yield data.

TABLE 10

| Compartment/ | Barley | Spray Used in | Malt Yield in 1,000 |
|---|---|---|---|
| Sample | Variety | Germination Stage | Kernel Weight |
| 1 | Sebastian | Reference (Water) | 36.1 |
| 2 | Sebastian | Prestige 100% Spray | 36.7 |
| 3 | Sebastian | Sebastian 100% Spray | 36.3 |
| 4 | Sebastian | Aruzel 100% Spray | 36.5 |
| 5 | Azurel | Reference (Water) | 36.0 |
| 6 | Azurel | Prestige 100% Spray | 36.0 |
| 7 | Azurel | Sebastian 100% Spray | 36.3 |
| 8 | Azurel | Aruzel 100% Spray | 36.1 |

Table 11 below shows the percent yield improvement for each experimental sample compared to the control samples (reference samples).

TABLE 11

| | Spray Used in | Malt Yield | Percent Yield Increase |
|---|---|---|---|
| Barley | Germination | in 1,000 | compared to |
| Variety | Stage | Kernel Weight | Reference |
| Sebastian | Reference (Water) | 36.1 | — |
| Sebastian | Prestige 100% | 36.7 | 1.7% |
| | Spray | | |
| Sebastian | Sebastian 100% | 36.3 | 0.6% |
| | Spray | | |
| Sebastian | Aruzel 100% | 36.5 | 1.1% |
| | Spray | | |
| Azurel | Reference (Water) | 36.0 | — |
| Azurel | Prestige 100% | 36.0 | 0% |
| | Spray | | |
| Azurel | Sebastian 100% | 36.3 | 0.8% |
| | Spray | | |
| Azurel | Aruzel 100% | 36.1 | 0.3% |
| | Spray | | |

### Example 4

As in Examples 1 and 2, a Joe White micromalting system was used to malt samples of barley. A sample of 0.5 kilogram of barley was added to each of 12 compartments in the micro-malting unit. Table 12 describes experimental conditions utilized in this example.

TABLE 12

| Compartment/ | Barley | Spray Used in |
|---|---|---|
| Sample | Variety | Germination Stage |
| 1 | Sebastian | Reference (Water) |
| 2 | Sebastian | Reference (Water) |
| 3 | Sebastian | Sebastian Spray 1 |
| 4 | Sebastian | Sebastian Spray 1 |
| 5 | Sebastian | Sebastian Spray 2 |
| 6 | Sebastian | Sebastian Spray 2 |
| 7 | Esterel | Reference (Water) |
| 8 | Esterel | Reference (Water) |
| 9 | Esterel | Esterel Spray 1 |
| 10 | Esterel | Esterel Spray 1 |
| 11 | Esterel | Esterel Spray 2 |
| 12 | Esterel | Esterel Spray 2 |

A two immersions steep cycle was used. In the first immersion, the barley was immersed in water for 9 hours at 15° C. followed by ventilation for 19 hours at 15° C. In the second immersion, the barley was immersed in water for 3 hours at 15° C. Following steeping, the barley was germinated for 5 days at 15° C. with a target moisture level of 45% at the end of germination. Table 13 below describes moisture content of the barley in each compartment at the end of day 1, 2, 3, 4, and 5, as well as the amount of water or barley extract sprayed onto the barley on day 1. A total of 100 mL of water or extract was sprayed onto the barley on day 1. This amount was separated into two equal sprays of 50 mL each. The first spray was applied at 12 hours into germination and the second spray at 16 hours into germination.

TABLE 13

| | Day 1 | | Day 2 | | Day 3 | | Day 4 | | Day 5 | |
|---|---|---|---|---|---|---|---|---|---|---|
| Compartment | Moist | Spray | Moist | Spray | Moist | Spray | Moist | Spray | Moist | Spray |
| 1 | 40.9% | 100 mL | 48.2% | — | 49.4% | — | 49.4% | — | 48.9% | — |
| 2 | 41.0% | 100 mL | 48.5% | — | 49.4% | — | 49.5% | — | 48.4% | — |
| 3 | 40.9% | 100 mL | 46.7% | — | 48.8% | — | 47.7% | — | 48.1% | — |
| 4 | 41.0% | 100 mL | 48.2% | — | 47.9% | — | 47.7% | — | 47.1% | — |
| 5 | 40.9% | 100 mL | 48.2% | — | 48.2% | — | 48.7% | — | 48.4% | — |
| 6 | 40.7% | 100 mL | 47.9% | — | 48.3% | — | 48.5% | — | 48.3% | — |
| 7 | 39.9% | 100 mL | 46.7% | — | 46.5% | — | 47.0% | — | 46.2% | — |
| 8 | 39.8% | 100 mL | 46.4% | — | 47.2% | — | 46.7% | — | 45.7% | — |
| 9 | 40.0% | 100 mL | 46.9% | — | 47.2% | — | 47.3% | — | 47.5% | — |
| 10 | 39.0% | 100 mL | 46.6% | — | 46.4% | — | 47.0% | — | 46.5% | — |
| 11 | 39.2% | 100 mL | 46.0% | — | 47.0% | — | 47.0% | — | 46.2% | — |
| 12 | 39.6% | 100 mL | 46.8% | — | 48.0% | — | 47.2% | — | 47.5% | — |

The barley extracts utilized as the spray (as listed in table 12) were obtained from purposefully producing barley extracts from Sebastian and Esterel varieties. Two different extracts were produced from each variety (Sebastian Spray 1 and Sebastian Spray 2, and Esterel Spray 1 and Esterel Spray 2).

Each “Spray 1” was produced in the following manner, except that a different barley variety (Sebastian or Esterel) was used: One kilogram of barley was placed in 1.4 liter of water and held at 15° C. for 20 hours. Each “Spray 2” was produced in the following manner, except that a different barley variety (Sebastian or Esterel) was used: One kilogram of barley was placed in 1.8 liter of water and held at 25° C. for 20 hours. The Sprays 1 and Sprays 2 were then applied to the germinating barely as shown in table 10 in the amounts and time indicated above and in table 11.

After 5 days of germination, the barley in each compartment was kilned with a standard kilning program.

Malt yield was measured in 1,000 kernel weight for each of the 12 samples. Table 14 displays this yield data.

TABLE 14

| Compartment/ | Barley | Spray Used in | Malt Yield in 1,000 |
|---|---|---|---|
| Sample | Variety | Germination Stage | Kernel Weight |
| 1 | Sebastian | Reference (Water) | 36.7 |
| 2 | Sebastian | Reference (Water) | 36.5 |
| 3 | Sebastian | Sebastian Spray 1 | 37.3 |
| 4 | Sebastian | Sebastian Spray 1 | 37.3 |
| 5 | Sebastian | Sebastian Spray 2 | 37.1 |
| 6 | Sebastian | Sebastian Spray 2 | 36.9 |
| 7 | Esterel | Reference (Water) | 34.3 |
| 8 | Esterel | Reference (Water) | 34.8 |
| 9 | Esterel | Esterel Spray 1 | 34.4 |
| 10 | Esterel | Esterel Spray 1 | 35.1 |
| 11 | Esterel | Esterel Spray 2 | 34.7 |
| 12 | Esterel | Esterel Spray 2 | 34.8 |

Table 15 below shows averages for each duplicate sample as well as the percent yield improvement provided by the barley extracts.

TABLE 15

| | Spray Used in | Average Malt | Percent Yield |
|---|---|---|---|
| Barley | Germination | Yield in 1,000 | Increase compared to |
| Variety | Stage | Kernel Weight | Reference |
| Sebastian | Reference (Water) | 36.6 | — |
| Sebastian | Sebastian Spray 1 | 37.3 | 1.9% |
| Sebastian | Sebastian Spray 2 | 37.0 | 1.1% |
| Esterel | Reference (Water) | 34.6 | — |
| Esterel | Esterel Spray 1 | 34.8 | 0.6% |
| Esterel | Esterel Spray 2 | 34.8 | 0.6% |

As seen in table 15, malt yield increased for the experimental samples compared to the reference. In particular, the samples using Sebastian spray showed greater yield increase.

### Example 5

This example was conducted to evaluate the ideal timing for addition of the barley extract during the germination stage of the malting process. As in Examples 1-4, a Joe White micromalting system was used to analyze samples of barley. One kilogram of barley was added to each of 4 compartments in the micro-malting unit. Table 16 describes experimental conditions utilized in this example.

TABLE 16

| Compartment/ | Barley | Spray Used in | Timing of water or Spray |
|---|---|---|---|
| Sample | Variety | Germination Stage | addition to Germination |
| 1 | Scarlett | Reference (Water) | Once after 8 hours |
| | | | into Germination |
| 2 | Scarlett | Reference (Water) | Once after 24 hours |
| | | | into Germination |
| 3 | Scarlett | Scarlett Spray | Once after 8 hours |
| | | | into Germination |
| 4 | Scarlett | Scarlett Spray | Once after 24 hours |
| | | | into Germination |

A three immersions steep cycle was used. In the first immersion, the barley was immersed in water for 6 hours at 15° C. followed by ventilation for 12 hours at 15° C. In the second immersion, the barley was immersed in water for 5 hours at 15° C. followed by ventilation for 10 hours at 15° C. In the final immersion, the barley was immersed for 2 hours at 15° C. Following steeping, the barley was germinated for 5 days at 15° C. with a target moisture level of 45% at the end of germination. Table 17 below describes moisture content of the barley in each compartment at the end of day 1, 2, 3, 4, and 5, as well as the amount of water or barely extract sprayed onto the barley at 8 hours (day 1) or at 24 hours (day 2) of germination.

TABLE 17

| | Day 1 | | Day 2 | | Day 3 | | Day 4 | | Day 5 | |
|---|---|---|---|---|---|---|---|---|---|---|
| Compartment | Moist | Spray | Moist | Spray | Moist | Spray | Moist | Spray | Moist | Spray |
| 1 | 44.6% | 100 mL | 45.6% | — | 47.9% | — | 49.8% | — | 49.0% | — |
| 2 | 43.8% | — | 39.2% | 100 mL | 47.2% | — | 48.7% | — | 47.4% | — |
| 3 | 44.3% | 100 mL | 41.5% | — | 48.0% | — | 49.3% | — | 48.8% | — |
| 4 | 44.8% | | 42.5% | 100 mL | 45.9% | — | 47.9% | — | 46.8% | — |

The barley extract utilized as the spray (as listed in table 16) were obtained from purposefully producing a barley extract from the Scarlett variety. The Scarlett barley extract was produced by submerging 1 kg of Scarlett barley in 1.4 L of water. The mixture was held for 24 hours with aeration at 15° C.

After 5 days of germination, the barley in each compartment was kilned. During the wither phase of kilning, the green malt was heated for 15 hours at 55° C. In the pre-cure/post wither phase, the temperature was gradually increased from 55° C. to 85° C. over 8 hours. During the cure phase, the barley was heated to 85° C. for 3 hours.

Malt yield was measured in 1,000 kernel weight for each of the 4 samples. Table 18 displays this yield data.

TABLE 18

| Compartment/ | Barley | Spray Used in | Malt Yield in 1,000 |
|---|---|---|---|
| Sample | Variety | Germination Stage | Kernel Weight |
| 1 | Scarlett | Reference (Water) 8 | 33.0 |
| | | hours into Germination | |
| 2 | Scarlett | Reference (Water) 24 | 33.0 |
| | | hours into germination | |
| 3 | Scarlett | Scarlett Spray 8 hours | 33.8 |
| | | into germination | |
| 4 | Scarlett | Scarlett Spray 24 hours | 33.0 |
| | | into germination | |

As seen in table 18, when the Scarlett Spay is applied to the germinating barley 24 hours into germination, there is no resulting increase in malt yield compared to the reference. However, when the Scarlett Spray is applied after 8 hours, a 2.4% yield increase occurs. This substantial 2.4% yield increase is surprising and would result in a substantial commercial advantage to the commercial maltster producing malt suitable for brewing beer.

### Example 6

Four trials were conducted which followed a methodology that varied barely extract concentrations, and timing and number of additions of the barely extract. Samples of steeped barley were obtained from Cargill, Incorporated's Spiritwood, N. Dak. commercial malting facility. The samples were obtained from the same commercial steeped batch, and after approximately one day of commercial germination, but before the first routine spraying (steeping out). Specifically, the samples of barley used in this example were obtained at 25, 26, 24, and 22 hours into commercial germination for trials 1, 2, 3, and 4 respectively.

Each sample then completed a 4 day germination process and kilning in an in-house designed micro-malting system. The in-house micro-malting system emulated a conventional large scale malting system for processing conditions. Germination continued in the in-house micro-malting system for approximately 3 more days. During the first 2 days of germination in the in-house micro-malting system, the barely was subjected to humidified air at a temperature of 56-58° F. (13-14° C.). The temperature was increased to 65° F. (18° C.) on the third day of germination in the in-house micro-malting system. The first watering (either water or barely extract) was applied to the germinating barely as soon as the germinating barley was transferred to the in-house micro-malting system (from the commercial germination compartment). A second watering was applied form trials 2, 3, and 4. The time of waterings is shown at table 19 below.

A 4 stage kilning cycle was utilized to kiln the barley in the in-house micro-malting system. The first stage was heated at 140° F. (60° C.) for 13.5 hours. In the second kilning stage, the green malt was heated at 165° F. (74° C.) for 5 hours. In the third kilning stage, the green malt was heated at 185° F. (85° C.) for 5 hours. The final kilning stage lasted for 0.5 hour, and the green malt was held 70° F. (21° C.). Increased airflow was utilized in the final kilning stage.

For this example, each barley extract was produced in the following manner: Steepwater was recovered from each of two commercial malting processes (one with the Metcalfe barely variety, and another with MV69 barley variety) at 8 hours in the first immersion. Each steepwater sample was then boiled down to 1/10 of the original volume (90% of the volume was boiled off). These concentrated barley extracts were then reconstituted with reverse osmosis (RO) water to produce barley extracts for use in this example. These barely extracts were reconstituted to concentrations of 100%, 10%, and 1% (in comparison to the original volume). For example, for the 100% concentration, sufficient RO water was added such the volume of the extract would be the same as that initially removed from the steeping stage. For the 10% concentration, sufficient RO water was added such that the volume was ten times the amount initially extracted from the steeping stage. For the 1% concentration, sufficient RO water was added such that the volume was 100 times the amount initially extracted from the steeping stage.

Table 19 below describes the experimental parameters for the four trials conducted in this example.

TABLE 19

| Trial | Extract Source | Barley Variety | Treatment Time |
|---|---|---|---|
| 1 | Metcalfe-first immersion at | Metcalfe | 25 hours into |
| | 8 hours | | germination |
| 2 | Metcalfe-first immersion at | Metcalfe | 26 hours and 48 hours |
| | 8 hours | | into germination |
| 3 | MV69-first immersion at 8 | Metcalfe | 24 hours and 48 hours |
| | hours | | into germination |
| 4 | MV69-first immersion at 8 | Metcalfe | 22 hours and 48 hours |
| | hours | | into germination |

Table 20 below describes the yield data in 1000 kernel weight for each of the four trials with each particular extract. Two control runs were performed for each trial. The control samples refer to trials in which water was sprayed onto the barley at the times described above rather than a barely extract.

TABLE 20

| Trial | Control 1 | Control 2 | 1% extract | 10% extract | 100% extract |
|---|---|---|---|---|---|
| 1 | 37.12 | 38.41 | 38.71 | 38.81 | 38.96 |
| 2 | 34.45 | 34.49 | 33.13 | 35.15 | 35.01 |
| 3 | 39.76 | 39.74 | — | 40.14 | 39.74 |
| 4 | 33.29 | 32.64 | — | 33.42 | 32.22 |

The table above shows that trials in which the extract was produced with the same barley variety as the barley being malted (trials 1 & 2) showed an improved yield in particular when utilizing the more highly concentrated extracts.

### Example 7

Five trials were conducted which followed a methodology that varied the barley variety used to produce the extract, and the timing of additions of the barely extract. Samples of steeped barley were obtained from Cargill, Incorporated's Spiritwood, N. Dak. commercial malting facility. The samples were obtained from different commercial steeped batches, and after approximately one day of commercial germination, but before the first routine spraying (steeping out). Specifically, the samples of barley used in this example were obtained at 21, 21, 20, 20, and 24 hours into commercial germination for trials 1, 2, 3, 4, and 5 respectively. Each sample then completed a 4 day germination process and kilning in an in-house designed micro-malting system with processing conditions similar to those of example 6.

The first watering (either water or barely extract) was applied to the germinating barely as soon as the germinating barley was transferred to the in-house micro-malting system (from the commercial germination compartment). A second watering was also applied to each sample. The time of waterings is shown at table 21 below.

The barley extracts utilized in this example were produced in the same manner as those described in example 6, except that all extracts utilized in this example were reconstituted to 100%.

Table 21 below describes the experimental parameters for the five trials conducted in this example.

TABLE 21

| Trial | Extract Source | Barley Variety | Treatment Time |
|---|---|---|---|
| 1 | Metcalfe-first immersion at | Metcalfe | 21 hours and 45 hours |
| | 11 hours | | into germination |
| 2 | Metcalfe-first immersion at | Tradition | 21 hours and 48 hours |
| | 11 hours | | into germination |
| 3 | Metcalfe-first immersion at | Tradition | 20 hours and 48 hours |
| | 11 hours | | into germination |
| 4 | Tradition-first immersion at | Tradition | 20 hours and 48 hours |
| | 11 hours | | into germination |
| 5 | Tradition-first immersion at | Lacey | 24 hours and 48 hours |
| | 11 hours | | into germination |

For each trial, two control samples and three experimental samples were run. Control samples were sprayed with water, while the experimental samples were sprayed with the barley extract. An average of the 1000 kernel weight was taken for the two control samples and three experimental samples for each trial. Table 22 below describes this yield data.

TABLE 22

| | Control | Experimental | Percent Yield |
|---|---|---|---|
| Trial | Average Yield | Average Yield | Improvement |
| 1 | 36.718 | 37.063 | 0.9% |
| 2 | 32.768 | 33.257 | 1.5% |
| 3 | 30.871 | 31.387 | 1.7% |
| 4 | 31.180 | 31.566 | 1.2% |
| 5 | 31.734 | 32.115 | 1.2% |

As seen in table 22 above, all samples produced utilizing a barley extract resulted in a substantial yield increase. When used on a commercial scale, such a yield improvement could provide a commercial maltster a large economic benefit.

1. A method for increasing yield in the malting process comprising:
applying an extract to germinating cereal grain in the germination stage of the malting process.

2. The method of claim 1, wherein the extract is a barley extract.

3. The method of claim 2, wherein the cereal grain is barley.

4. The method of claim 3, wherein the barley extract is sprayed onto the cereal grain.

5. The method of claim 3, wherein the barley extract that is applied to the barley in the germination stage of the malting process is obtained from steepwater in the steeping stage of the same malting process.

6. The method of claim 3, wherein the barley extract is produced by submerging barley in water for at least about 1 hour to about 18 hours.

7. (canceled)

8. The method of claim 6, wherein the ratio of water to barley used to produce the barley extract is about 1:1 to about 10:1.

9. (canceled)

10. The method of claim 6, wherein the barley extract is applied to the cereal grain within about 8 hours to about 72 hours from the start of germination.

11. The method of claim 8, wherein the barley extract is applied to the cereal grain within about 8 hours to about 72 hours from the start of germination.

12. The method of claim 8, wherein the barley extract is applied to the cereal grain between about 4 hours to about 30 hours from the start of germination.

13. The use of an extract in the germination stage of the malting process to increase malt yield, wherein the extract is applied to cereal grains during the germination stage.

14. The use according to claim 13, wherein the extract is a barley extract.

15. The use according to claim 14, wherein the cereal grain is barley.

16. The use according to claim 15, wherein the barley extract is sprayed onto the cereal grain.

17. The use according to claim 15, wherein the barley extract is produced by submerging barley in water for at least about 6 hours to about 18 hours.

18. (canceled)

19. The use according to claim 17, wherein the ratio of water to barley used to produce the barley extract is about 1:1 to about 10:1.

20. (canceled)
